(19) United States
(12) Patent Application Publication
(10) Pub. No.: US 2020/0184371 A1
(43) Pub. Date: Jun. 11, 2020

(54) METHOD AND SYSTEM FOR FACILITATING COMBINING CATEGORICAL AND NUMERICAL VARIABLES IN MACHINE LEARNING

(71) Applicant: Armand Prieditis, Arcata, CA (US)

(72) Inventor: Armand Prieditis, Arcata, CA (US)

(21) Appl. No.: 16/216,853

(22) Filed: Dec. 11, 2018

(51) Int. Cl. G06N 20/00; G06N 7/00

(52) U.S. Cl. CPC G06N 20/00; G06N 7/005

(57) ABSTRACT

One embodiment of the subject matter combines categorical and numerical variables in machine learning based on a difference table for categorical variables. During operation, the system performs the following steps. First, the system receives an input value of a categorical variable. Next, the system determines a prediction based on the input value of the categorical variable, a most likely value of the categorical variable, and a difference table for the categorical variable, where the most likely value of the categorical variable is based on a plurality of values of the categorical variable and where the difference table for the categorical variable comprises a number for each pair of values of the categorical variable. Subsequently, the system produces a result that indicates the prediction.

### BACKGROUND

### Field

The subject matter relates generally to machine learning. More specifically, the subject matter relates to combining categorical variables with numerical variables for supervised and unsupervised machine learning.

### Related Art

A categorical variable is one that can assume a fixed number of values. For example, a binary variable is categorical because it can assume the value 0 (false) or the value 1(true). Categorical variables are not limited to binary ones. For example, a categorical variable for color can assume the values red, blue, or green. In contrast, numerical variables are real-valued and can assume an infinite number of values. For example, a numerical variable (also known as a floating point, continuous, or decimal variable) representing temperature might assume the value 98.6.

Categorical variables arise in many machine learning applications. When the target to predict (i.e., the dependent variable) is categorical, the machine learning problem is called classification. This type of problem is solvable with many different machine learning methods such as random-forest decision trees and Naive Bayes classification. In contrast, when the target variable is real-valued, the machine learning problem is called regression. Dozens of techniques exist for regression including Ordinary Least Squares, Lasso, and Ridge Regression.

Some machine learning system such as neural networks can only process numerical variables as both the input (independent) and target (dependent) variables. As a result, all categorical variables must be encoded as numerical ones prior to processing with such machine learning systems.

One such popular encoding is called One-Hot encoding, which encodes each categorical variable value as a separate numerical value which can assume values 0 or 1. For example, consider a categorical variable for Race, which can assume values Hispanic, Asian, African-American, and Caucasian. In

One-Hot encoding, Hispanic can be encoded as four separate columns, all containing zeros, except for the first column, which corresponds to Hispanic. Asian can be encoded as four separate columns, 0,1, 0, 0; African-American, 0,0,1,0; and Caucasian, 0,0,0,1.

Note that three columns are sufficient to capture the required information. This is what Dummy encoding does. Hispanic is thus encoded as three (not four) columns, containing all zeros, Asian as 1,0,0, African American as 0,1,0, and Caucasian as 0,0,1. Deviation coding is like Dummy encoding except that the value with all zeros (e.g., Hispanic) is encoded as all −1s.

Simple encoding is similar to One-Hot encoding in that each level is compared to a reference level. With k categorical values, the non-zero entry (one per row) in simple encoding is (k−1)/k and the zero entries are −1/k. Thus, Simple encoding suffers from the same problems as One-Hot encoding.

Binary encoding assigns an ordinal number to each categorical value and then translates that ordinal number into its binary version, containing n bits. Each of the bits then becomes a column with either a 0 or a 1. Thus Binary encoding is similar to One-Hot encoding, but with a preliminary step of ordinal-to-binary transformation. Hashing encoding transforms each categorical variable value to one of k buckets by hashing on the variable value (e.g., based on an assigned ordinal value or the characters of the variable value) and then transforming the resulting hash into k columns, where a column has a 1 if the categorical variable value hashed to k and a 0 otherwise.

Helmert coding involves transforming the first of k categorical variables into k columns with the following entries: 1, −1/(k−1), . . . , −1/(k−1), −1/(k−1). The second of k categorical variables also into k columns but with the following entries 0, 1, . . . , −1/(k−2), −1/(k−2). The i^{th} of k categorical variables thus has i−1 leading zeros, followed by a 1, followed by k−i entries of −1/(k−i). For example, the (k−2)^{nd} categorical variable is encoded as k−3 leading zeros, then a 1, and then 2 entries of −1/2. The (k−1)^{st} column (the final one) has k−2 leading zeros, followed by a 1, followed by a −1.

Other less-popular methods to encode categorical variables include the Sum, Polynomial, Backward Difference, Forward Difference, BaseN, LeaveOneOut, and Target methods.

All of these methods suffer from several shortcomings. First, they are sensitive to the order in which the encodings are made: the categorical variable values can be permuted so that they map to a different encoding. One permutation of categorical variables can lead to radically different results. Second, although only one of the category values can be true at one time, the machine learning system does not know that the encoded columns are linked with this constraint.

For example, in One-Hot encoding, all the column values for a row must add up to 1, but the underlying machine learning system does not know about this relationship between encoded columns in its learning routines. It is possible for a machine learning system to learn such relationships between encoded columns, but this is at the cost of computational time that could be better spent learning the relationship between the inputs and the target column.

Third, a single categorical variable with many values can result in a large number of additional columns. For example, a categorical variable with a thousand values can result in approximately one thousand additional columns, which can lead to both overfitting and instability of the machine learning algorithm.

Ordinal encoding can eliminate the column blow up problem by maintaining a single column for each categorical variable by translating each categorical value to an integer. The advantage of ordinal encoding is that the resulting encoding can be treated just like a numerical variable. One problem with this method is that it can make two categorical variable values arbitrarily close, when in fact they are not. For example, the color category values of red, blue, and can be ordinal-encoded such that red=1, blue=2, and green=3. This ordinal encoding arbitrarily makes it appear that blue is closer to green than red is. No ordinal encoding can escape this problem of arbitrary closeness for this or any other categorical variable.

Another approach is to separate the categorical from the numerical variables for prediction. For example, the categorical variables might have their own probability distribution, distinct from the numerical values. The prediction can be based on the product of these two distinct distributions. This method has several shortcomings. First, this method is difficult to apply when the target is numerical (i.e. regression). Second, this method does not directly capture interactions between categorical and numerical variables. Third, this method still requires a way to represent the joint probability distribution of both the categorical and numerical variables.

In the extreme, every variable can have its own probability distribution, which is what a Naive Bayes classifier does. This type of classifier separates all variables, whether categorical or numerical, based on the conditional independence assumption. That is,

$$p ( c \vert x ) = \frac{{\prod }_{i = 1}^{n} p ( {x}_{i} \vert c ) p ( c )}{K} ,$$

where c is the class, x is the vector of variables, which can be both categorical and numerical, and K is a normalizing constant.

Since Bayes Rule specifies that the class c with the largest p(c|x) should be chosen as the best prediction, the normalizing constant can be ignored (i.e., it is the same for every class) and the expression can be simplified for particular distributions by applying the ln transformation to eliminate exponentials. If xᵢ is categorical, p(xᵢ|c) can represented by the frequency distribution of various values for xᵢ. If xᵢ is numerical, p(xᵢ|c) can represented by a univariate Gaussian with mean μ and variance σ. Although this representation is compact, it is limited to classification (i.e. it cannot be applied to regression) problems and it does not capture pairwise relationships between each xᵢ.

Hence, what is needed is a method and a system that facilitates combining categorical and numerical variables through a compact but non-arbitrary encoding while capturing interactions between variables and facilitating both regression and classification.

### SUMMARY

One embodiment of the subject matter combines categorical and numerical variables in machine learning based on a difference table for categorical variables. This difference table can be used in a Multivariate Gaussian distribution whose parameters comprise most likely values for each categorical variable and a covariance matrix that that can comprise a covariance between each categorical and numerical variable, between pairs of categorical two numerical variables, and between pairs of two categorical variables.

Particular embodiments of the subject matter can be implemented so as to realize a compact but non-arbitrary encoding of categorical variables while capturing interactions between variables and facilitating both supervised learning (regression and classification) as well as unsupervised learning (e.g., clustering). Embodiments of the subject matter can also facilitate prediction in the presence of missing inputs.

The details of one or more embodiments of the subject matter are set forth in the accompanying drawings and the description below. Other features, aspects, and advantages of the subject matter will become apparent from the description, the drawings, and the claims.

### BRIEF DESCRIPTION OF THE FIGURES

FIG. 1 shows an example system for facilitating combining categorical with numerical variables in machine learning.

FIG. 2 shows an example of difference table for a categorical variable.

FIG. 3 presents a flow diagram of an example process for facilitating combining categorical with numerical variables in machine learning.

In the figures, like reference numerals refer to the same figure elements.

### DETAILED DESCRIPTION

Embodiments of the subject matter can be used to predict a target that can be categorical (classification) or numerical (regression). For simplicity of presentation, we will denote a variable—whether categorical or numerical—by a corresponding index i rather than by a name. Also for simplicity of presentation, we will denote a categorical variable value by a corresponding index j. This method of denoting variables and categorical variable values is merely a notational convenience and does not affect embodiments of the subject matter. Other equivalent notational methods can be used.

In embodiments of the subject matter, classification involves determining g(x,b,i):

$$g ( x , b , i ) = argmin \{ s ( x , b , i , j ) \vert 1 \leq j \leq m ( i ) \}$$

$$s ( x , b , i , j ) = \frac{{( x - {μ}_{b , i , j} )}^{T} {Σ}_{b , i , j}^{- 1} ( x - {μ}_{b , i , j} ) + ln \vert {Σ}_{b , i , j} \vert}{1} - ln {p}_{i , j}$$

Here, i is the category index for classification, x is a column vector of values, b is a corresponding vector of variable indices of those values in x, m(i) is the number of values for category i, argmin returns that variable value j of category i for which s(x,b,i,j) is lowest (ties are broken arbitrarily), μ_{b,i,j} is a corresponding column vector of most likely values for the indices b, given categorical variable i with value j, Σ_{b,i,j} is a covariance matrix for the variables indexed by b, given categorical variable i with value j, E_{b,i,j}⁻¹ is an inverse of the covariance matrix, |Σ_{b,i,j}| is a determinant of the covariance matrix, p_{i,j} is a probability categorical variable i with value j, T is the transpose operator, and 1n is the natural logarithm.

The operator—is a vector minus operation whose element-wise operator—is a standard minus when its two corresponding elements are numerical. However, when its two corresponding elements are categorical, the result is still numerical but is based on a difference table associated with the categorical variable, indexed by each pair of categorical variable values.

The difference table can be viewed as a distance between each pair of categorical variable values. Hence, the difference between the same two categorical variable values is by definition zero.

Note that μ_{b,i,j} is a column vector whose elements μ_{b,i,j,k} are defined as follows. If the k^{th} variable in b is numerical,

$${μ}_{b , i , j , k} = \frac{{\sum }_{t = 1}^{m ( i , j )} {x}_{b , i , j , k , t}}{m ( i , j )} ,$$

where m(i,j) denotes the number of times categorical variable i with value j occurs in the data x, where x_{b,i,j,k,t} corresponds to the t^{th} occurrence in the data of the k^{th} variable value of b, given categorical variable i with value j. In other words, μ_{b,i,j,k} is the mean of the k^{th} variable value in b, given categorical variable value i with value j.

If the k^{th} variable in b is categorical,

$${μ}_{b , i , j , k} = argmax \{ \frac{{\sum }_{t = 1}^{m ( i , j )} [ {x}_{i , b , j , k , t} = c ]}{, ( i , j )} \vert 1 \leq c \leq m ( k ) \} where [ xb , i , j , k , t = c ]$$

is Iverson notation, which returns a 1 when x_{b,i,j,k,t} is equal to variable value c and 0 otherwise. The function argmax returns the c associated with the largest

$$\frac{{\sum }_{t = 1}^{m ( i , j )} [ {x}_{b , i , j , k , t} = c ]}{m ( i , j )} .$$

This is the most likely variable value of the k^{th} variable value in b, given variable i with value j, over all the data points x with variable i and value j. Ties between two equally likely categorical variable values in argmax can be broken arbitrarily or based on a specified criteria.

Note that unlike i, which refers to the i^{th} variable, k here refers to the variable number indexed in b. For example, if b comprises the vector <2,5,7,10>, which refers to variables 5, 7, 2, and 10, when k=1, k refers to variable 2, when k=2, k refers to variable 5, when k=3, k refers to variable 7, and when k=4, k refers to variable 10. The indexing scheme here starts with 1, but other indexing schemes can serve the same purpose.

The k^{th} and l^{th} values of b in the covariance matrix Σ_{b,i,j} given categorical variable j with value i is defined as follows:

$${Σ}_{b , i , j , k , l} = \frac{{\sum }_{t = 1}^{m ( i , j )} ( {x}_{b , i , j , k , t} - {μ}_{b , u , j , k} ) ( {x}_{b , i , j , l , t} - {μ}_{b , i , j , l} )}{m ( i , j )} ,$$

where the operator—is defined as above. Thus, the covariance matrix Σ_{b,i,j} can be based on both numerical and categorical variables. The diagonal of the covariance matrix contains the variances of the variables.

Furthermore, if the target is categorical, there is one such covariance matrix for each value of the categorical target. A categorical target can be used for both supervised learning and unsupervised learning (e.g., clustering).

Other methods can be used to approximate or determine p_{i,j}, μ_{b,i,j}, and Σ_{b,i,j}. For example, the inverse of the covariance matrix can be approximated directly. The probability p_{i,j} can be based on constants added to the numerator and denominator to avoid divide-by-zero errors or to include prior knowledge.

The covariance matrix can have a small random value added to each element of the diagonal to prevent singularity.

Note that the covariance matrix can be diagonal, which simplifies the inversion to be the inverse of the diagonal entries. The covariance matrix can also be the identity matrix I, which facilitates simplifying the equation for s(x,b,i,j) to

$$\frac{{( x - {μ}_{b , i , j} )}^{T} ( x - {μ}_{b , i , j} )}{2} - ln {p}_{i , j} .$$

Each diagonal element of the identity matrix I is the multiplicative identity, which is defined as 1; each off diagonal element of the identity matrix I is the additive identity, which is defined as 0. If the prior probability p_{i,j} is ignored (i.e., set to 1), this equation can be further simplified to s(x,b,i,j)=(x−μ_{b,i,j})^{T}(x−μ_{b,i,j}). This equation can be used to facilitate both supervised learning and unsupervised learning (such as k-means clustering).

When the target is one or more numerical variables, the prediction form is ƒ(x,b,α), where:

ƒ(x, b, α)=μ_{α}+Σ_{α,b}Σ_{b}⁻¹(x−μ_{b})

Here, x is a column vector of input variable values, b is a corresponding vector of input variable indices, α is a vector of target numerical variable indices, μ_{α} is a column vector corresponding to the mean values of the variables indexed by α, Σ_{a,b} is a covariance matrix (as defined above) for the variables indexed by α on the row axis and the variables indexed by b on the column axis, Σ_{b} is a covariance matrix (as defined above) for the variables indexed by b on both the rows and columns, μ_{b} is a column vector of the most likely values (as defined above) for the variables indexed by b, and the operator—is as defined above.

As described above, E_{b} can be simplified to a diagonal matrix (i.e. of variances) or the identity matrix I. In the latter case, the equation simplifies to: ƒ(x, b, α)=μ_{α}+Σ_{α,b}(x−μ_{b}). These and all of the above simplifications can facilitate faster computation though at a potential loss in accuracy. Note that Σ_{b}⁻¹ can be estimated directly or approximated based on the data.

Embodiments of the subject matter can facilitate supervised or unsupervised learning with missing values as follows. Those variables that are not missing are described in b, along with their corresponding values in x. The remaining variables are assumed to be missing. In a multivariate Gaussian, this property is known as marginalization. In a multivariate Gaussian, marginalizing over a set of missing variables is equivalent to ignoring those variables: the results in prediction are the same. Hence, the missing variables in a Gaussian can be ignored in prediction. The same property holds for embodiments of the subject matter.

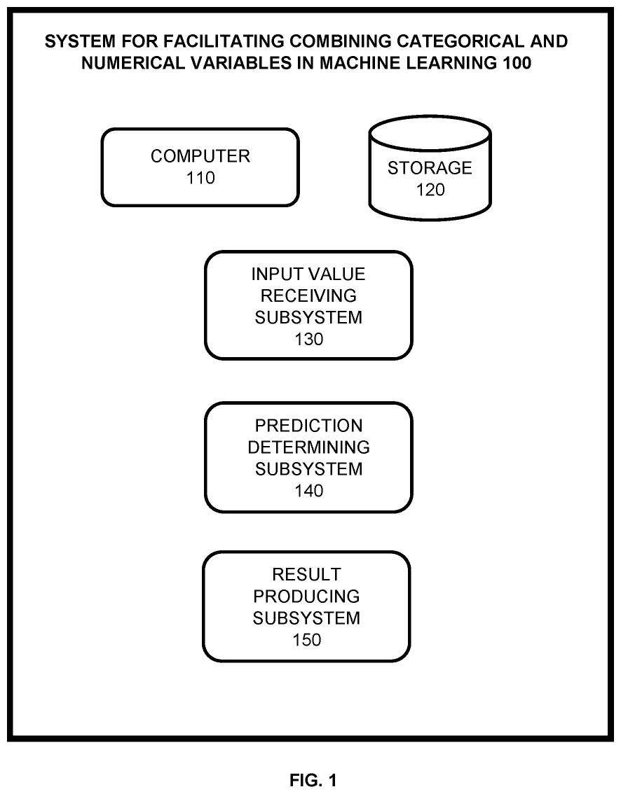

FIG. 1 shows an example system for facilitating combining categorical with numerical variables in machine learning in accordance with an embodiment of the subject matter. System for facilitating combining categorical with numerical variables in machine learning 100 (henceforth system 100) is an example of a system implemented as a computer program on one or more computers in one or more locations (shown collectively as computer 110), with one or more storage devices in one or more locations (shown collectively as storage 120), in which the systems, components, and techniques described below can be implemented.

System 100 activates input value receiving subsystem 130 for receiving an input value of a categorical variable. Next, system 100 activates prediction determining subsystem 140 for determining a prediction based on the input value of the categorical variable, a most likely value of the categorical variable, and a difference table for the categorical variable, where the most likely value of the categorical variable is based on a plurality of values of the categorical variable and where the difference table for the categorical variable comprises a number for each pair of values of the categorical variable. Subsequently, system 100 activates result producing subsystem 150 for producing a result that indicates the prediction.

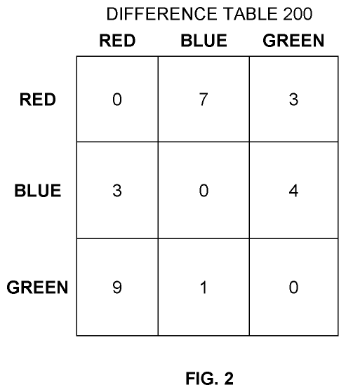

FIG. 2 shows an example of a difference table for a categorical variable. The table shows a categorical variable named color with values red, blue, green. The numerical entries in the table correspond to nine differences: red-red, red-blue, red-green, blue-red, blue-blue, blue-green, green-red, green-blue, and green-green. For example, red-green in the table corresponds to a numerical value of 3. Note that the entries for pairs of the same variable value correspond to a numerical value of 0. The rows and columns can be interchanged and the table can be represented as a function, an association list, a data dictionary, a hash table, or similar lookup data structures.

Note that difference table is not the same as the difference between two ordinal encodings of a categorical variable. As mentioned above, ordinal encodings arbitrarily make two variable value appear to each other than to other variable values. A difference table can avoid that shortcoming. In general, the difference table will not correspond to an ordinal encoding of the variable values.

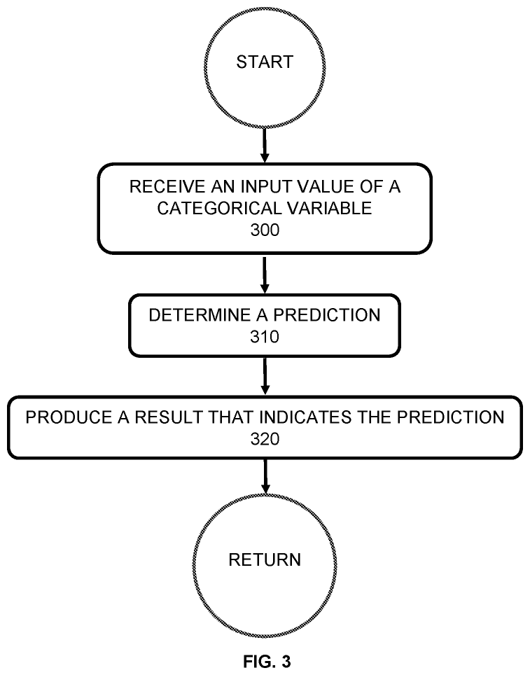

FIG. 3 presents a flow diagram of an example process for facilitating combining categorical with numerical variables in machine learning. For convenience, the process shown in FIG. 3 will be described as being performed by a system of one or more computers located in one or more locations. During operation, the system performs the following steps.

First, the system receives an input value of a categorical variable 300. Next, the system determines a prediction 310 based on the input value of the categorical variable, a most likely value of the categorical variable, and a difference table for the categorical variable, where the most likely value of the categorical variable is based on a plurality of values of the categorical variable and where the difference table for the categorical variable comprises a number for each pair of values of the categorical variable. Subsequently, the system produces a result that indicates the prediction 320.

The system can receive the input value of the categorical variable, transmit to subsystems, and produce a result that indicates the prediction through a communication system, which can be any known or later developed device or system for connecting a computer to a receiver, including a direct cable connection, a connection over a wide area network or a local area network, a connection over an intranet, a connection over the Internet, or a connection over any other distributed processing network or system. Further, the communication links can be wired or wireless links to a network. The network can be a local area network, a wide area network, an intranet, the Internet, or any other distributed processing and storage network. Moreover, components of the system can be interconnected by any form or medium of digital data communication, e.g., a communication network. Examples of communication networks include a local area network (“LAN”) and a wide area network (“WAN”), e.g., the Internet.

The preceding description is presented to enable any person skilled in the art to make and use the subject matter, and is provided in the context of a particular application and its requirements. Various modifications to the disclosed embodiments will be readily apparent to those skilled in the art, and the general principles defined herein may be applied to other embodiments and applications without departing from the spirit and scope of the subject matter. Thus, the subject matter is not limited to the embodiments shown, but is to be accorded the widest scope consistent with the principles and features disclosed herein.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non-transitory program carrier for execution by, or to control the operation of data processing system.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

Alternatively, or in addition, the program instructions can be encoded on an artificially generated propagated signal, e.g., a machine-generated electrical, optical, or electromagnetic signal, that is generated to encode information for transmission to a suitable receiver system for execution by a data processing system. The computer storage medium can be a machine-readable storage device, a machine-readable storage substrate, a random or serial access memory device, or a combination of one or more of them.

Computers suitable for the execution of a computer program include, by way of example, can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data.

A computer can also be distributed across multiple sites and interconnected by a communication network, executing one or more computer programs to perform functions by operating on input data and generating output.

A computer can also be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Generally, a computer will also include, or be operatively coupled to receive data from or transfer data to, or both, one or more mass storage devices for storing data, e.g., magnetic, magneto optical disks, or optical disks. However, a computer need not have such devices.

The term “data processing system” encompasses all apparatus, devices, and machines for processing data, including by way of example a programmable processor, a computer, or multiple processors or computers.

For a system of one or more computers to be configured to perform particular operations or actions means that the system has installed on it in software, firmware, hardware, or a combination of them that in operation cause the system to perform the operations or actions. For one or more computer programs to be configured to perform particular operations or actions means that the one or more programs include instructions that, when executed by data processing system, cause the system to perform the operations or actions.

The processor and the memory can be supplemented by, or incorporated in, special purpose logic circuitry. More generally, the processes and logic flows can also be performed by and be implemented as special purpose logic circuitry, e.g., an FPGA (field programmable gate array) or an ASIC (application specific integrated circuit), a dedicated or shared processor that executes a particular software module or a piece of code at a particular time, and/or other programmable-logic devices now known or later developed. When the hardware modules or system are activated, they perform the methods and processes included within them.

The system can also include, in addition to hardware, code that creates an execution environment for the computer program in question, e.g., code that constitutes processor firmware, a protocol stack, a database management system, an operating system, or a combination of one or more of them.

The computer-readable storage medium includes, but is not limited to, volatile memory, non-volatile memory, magnetic and optical storage devices such as disk drives, magnetic tape, CDs (compact discs), DVDs (digital versatile discs or digital video discs), computer instruction signals embodied in a transmission medium (with or without a carrier wave upon which the signals are modulated), and other media capable of storing computer-readable media now known or later developed. For example, the transmission medium may include a communications network, such as a LAN, a WAN, or the Internet.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The methods and processes described in the detailed description section can be embodied as code and/or data, which can be stored in a computer-readable storage medium as described above. When a computer system reads and executes the code and/or data stored on the computer-readable storage medium 120, the computer system performs the methods and processes embodied as data structures and code and stored within the computer-readable storage medium.

While this specification contains many specific implementation details, these should not be construed as limitations on the scope of any subject matter or of what may be claimed, but rather as descriptions of features that may be specific to particular embodiments of particular subject matters. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system modules and components in the embodiments described above should not be understood as requiring such separation in all embodiments, and it should be understood that the described program components and systems can generally be integrated together in a single software product or packaged into multiple software products.

The foregoing descriptions of embodiments of the subject matter have been presented only for purposes of illustration and description. They are not intended to be exhaustive or to limit the subject matter to the forms disclosed. Accordingly, many modifications and variations will be apparent to practitioners skilled in the art. Additionally, the above disclosure is not intended to limit the subject matter. The scope of the subject matter is defined by the appended claims.

What is claimed is:

1. A computer-implemented method for facilitating combining categorical variables with numerical variables in machine learning, comprising:
receiving an input value of a categorical variable;
determining a prediction based on the input value of the categorical variable, a most likely value of the categorical variable, and a difference table for the categorical variable,
wherein the most likely value of the categorical variable is based on a plurality of values of the categorical variable, and
wherein the difference table for the categorical variable comprises a number for each pair of values of the categorical variable; and
producing a result that indicates the prediction.

2. The method of claim 1,
wherein determining a prediction is additionally based on a variance of the categorical variable, and
wherein the variance is based on a plurality of values of the categorical variable, the most likely value of the categorical variable, and the difference table for the categorical variable.

3. The method of claim 2,
wherein the variance is based on a multiplicative identity. One or more non-transitory computer-readable storage media storing instructions that when executed by one or more computers cause the one or more computers to perform operations for facilitating compression, comprising:
receiving an input value of a categorical variable;
determining a prediction based on the input value of the categorical variable, a most likely value of the categorical variable, and a difference table for the categorical variable,
wherein the most likely value of the categorical variable is based on a plurality of values of the categorical variable, and
wherein the difference table for the categorical variable comprises a number for each pair of values of the categorical variable; and
producing a result that indicates the prediction.

4. The one or more non-transitory computer-readable storage media of claim 3,
wherein determining a prediction is additionally based on a variance of the categorical variable, and wherein the variance is based on a plurality of values of the categorical variable, the most likely value of the categorical variable, and the difference table for the categorical variable.

5. The one or more non-transitory computer-readable storage media of claim 8,
wherein the variance is based on a multiplicative identity.

6. A system comprising one or more computers and one or more storage devices storing instructions that when executed by the one or more computers cause the one or more computers to perform operations for facilitating compression, comprising:
receiving an input value of a categorical variable;
determining a prediction based on the input value of the categorical variable, a most likely value of the categorical variable, and a difference table for the categorical variable,
wherein the most likely value of the categorical variable is based on a plurality of values of the categorical variable, and
wherein the difference table for the categorical variable comprises a number for each pair of values of the categorical variable; and
producing a result that indicates the prediction.

7. The system of claim 6,
wherein determining a prediction is additionally based on a variance of the categorical variable, and
wherein the variance is based on a plurality of values of the categorical variable, the most likely value of the categorical variable, and the difference table for the categorical variable.

8. The system of claim 7,
wherein the variance is based on a multiplicative identity.
